(19) United States
(12) Patent Application Publication
(10) Pub. No.: US 2026/0275808 A1
(43) Pub. Date: Sep. 17, 2026

(54) MULTI-MODE UP-DOWN SHADE

(71) Applicants: Siyu Wu, Xiamen (CN); Mingliang Wu, Xiamen (CN)

(72) Inventor: Mingliang WU, Xiamen (CN)

(21) Appl. No.: 19/676,856

(22) Filed: May 14, 2026

Related U.S. Application Data
(63) Continuation-in-part of application No. PCT/CN2025/115552, filed on Aug. 19, 2025.

(30) Foreign Application Priority Data
Sep. 2, 2024 (CN) 202422136748.6

(51) Int. Cl. E06B 9/42; E06B 9/24; E06B 9/58

(52) U.S. Cl. CPC E06B 9/42; E06B 9/58; E06B 2009/2405; E06B 2009/2441

(57) ABSTRACT

A multi-mode up-down shade includes a roller, a cord fabric, an adjusting rod, a falling element, and a pair of positioning elements. The cord fabric, including at least one light-transmitting and one light-tight section, is wound around the roller with its head end fixed. The adjusting rod, connected to the fabric's tail end, has a slot through which the fabric's middle part is threaded. The falling element, slidably mounted on this part below the rod, folds the fabric into a double-layer structure. The positioning elements slide vertically between limits and can stop anywhere to define a stopping position for the rod. When raised, the falling element abuts and rises with the rod. When lowered, both descend until the positioning elements arrest the rod, after which the falling element continues descending.

### CROSS-REFERENCE TO RELATED APPLICATIONS

The present disclosure is a Continuation-in-part of PCT Application No. PCT/CN2025/115552, filed on Aug. 19, 2025, which claims the priorities of Chinese Utility Model application No. 202422136748.6, filed on Sep. 2, 2024, and the U.S. patent application Ser. No. 18/896,942, filed on Sep. 26, 2024, the entire contents of which are hereby incorporated by reference.

### TECHNICAL FIELD

The present disclosure relates to the field of window shading, and in particular to a multi-mode up-down shade.

### BACKGROUND

A window is a part of a building structure which is configured for lighting or ventilation of the indoor space of a building. A shade is generally installed inside the window, by which the window can be completely or partially covered, thereby adjusting light intensity entering the indoor space from the window.

Typically, the shade is generally entirely light-tight. A roller is installed at the top of the window, and the shade can be completely rolled up around an outer periphery of the roller, so that the window is in a full light-transmitting mode. The shade can also be partially released and pulled down from the roller, which results in that the upper part of the window is shaded by the shade, and the lower part of the window is light-transmitting. When the window is completely shaded by the shade, the shade is in a full light-tight mode.

However, in the full light-transmitting mode, indoor privacy cannot be protected, and work or rest of indoor people is liable to be disturbed by activities outside the window, especially in low-rise buildings. In a partial light-transmitting mode, the upper part of the window is shaded, and outdoor natural light enters the room from the lower part of the window, since an activity region of the indoor people is generally at or below a middle portion of the window, the indoor privacy can only be protected to a limited extent by the shade, and activities of the indoor people may still be visible from the lower part of the window. In addition, the outdoor natural light is blocked by the shade, thereby resulting in a significant decrease in brightness of indoor environment. In order to meet needs of indoor privacy protection, the shade has to be further pulled down by the indoor people to the full light-tight mode. At this time, the outdoor natural light is completely prevented by the shade; as a result, the indoor environment cannot be illuminated by the outdoor natural light.

### SUMMARY

In view of the above, the present disclosure provides a multi-mode up-down shade that can solve or at least alleviate above technical problems.

The present disclosure provides a multi-mode up-down shade, including:
a roller;
a cord fabric, entirely or partially wound around an outer periphery of the roller, wherein
a head end of the cord fabric is fixedly connected to the roller, and the cord fabric includes at least one light-transmitting section and at least one light-tight section;
an adjusting rod, fixedly connected to a tail end of the cord fabric away from the roller; wherein the adjusting rod is provided with a penetrating slot, a middle part of the cord fabric is slidably threaded through the penetrating slot, and the middle part of the cord fabric is a region located between the head end and the tail end of the cord fabric;
a falling element, slidably mounted on the middle part of the cord fabric and located below the adjusting rod, so that the middle part of the cord fabric is folded below the adjusting rod to form a double-layer structure; and a pair of positioning elements, configured to be slidable along a vertical direction within
a sliding displacement range between an upper extreme position and a lower extreme position, and configured to stop at any position within the sliding displacement range to form a stopping position for positioning the adjusting rod;
wherein, when the cord fabric is lifted, the falling element abuts against the adjusting rod and is lifted together with the cord fabric; and
wherein when the cord fabric is lowered, the falling element and the adjusting rod are first lowered together with the cord fabric until the adjusting rod is blocked by the pair of positioning elements at the stopping position, and the falling element continues to be lowered together with the cord fabric.

The above multi-mode up-down shade, by configuring the pair of positioning elements to be slidable along the vertical direction and to be able to stop at any height between the upper extreme position and the lower extreme position, enables a user to flexibly and precisely set the stopping position of the adjusting rod according to actual needs.

During the lowering of the cord fabric, the adjusting rod and the tail end of the cord fabric connected thereto can be accurately blocked and suspended at any preset height by the user, while the falling element slides downward as the cord fabric continues to descend. Simultaneously, the middle part of the cord fabric continues to move downward, passing through the penetrating slot of the adjusting rod and hanging down, thereby causing the cord fabric below the adjusting rod to fold into a double-layer structure, while the cord fabric above the adjusting rod remains a single-layer structure.

Based on this structure, the user can change the relative positions of the light-transmitting section and the light-tight section on the cord fabric simply by controlling the suspension height of the adjusting rod and performing basic lifting and lowering operations of the cord fabric. This enables the shade to have multiple working states, thereby meeting diverse user needs and improving the user experience.

### BRIEF DESCRIPTION OF DRAWINGS

FIG. 1 is a perspective schematic view of a multi-mode up-down shade according to one embodiment of the present disclosure, wherein a cord fabric is completely wound around an outer periphery of a roller, and the window is in full light-transmitting state.

FIG. 2 is a perspective schematic view of the multi-mode up-down shade shown in FIG. 1 in another state.

FIG. 3A is a perspective schematic view of the multi-mode up-down shade shown in FIG. 1 in another state, wherein a first positioning element pair and a second positioning element pair are spaced apart in a vertical direction, a height level of the second positioning element pair is arranged higher than a height level of the first positioning element pair, the second positioning element pair is in an unlocked position and the first positioning element pair is in a locked position, an adjusting rod is supported at the first positioning element pair, and a falling element is located higher than a bottom edge of the window.

FIG. 3B is a side view of the multi-mode up-down shade shown in FIG. 3A.

FIG. 4A is a perspective schematic view of the multi-mode up-down shade shown in FIG. 3A in another state, and a level of the falling element is aligned with the bottom edge of the window.

FIG. 4B is a side view of the multi-mode up-down shade shown in FIG. 4A.

FIG. 5A is a perspective schematic view of the multi-mode up-down shade shown in FIG. 1 in another state, wherein the second positioning element pair is in the locked position and the first positioning element pair is in the unlocked position, the adjusting rod is supported at the second positioning element pair, and the falling element is located higher than the bottom edge of the window.

FIG. 5B is a side view of the multi-mode up-down shade shown in FIG. 5A.

FIG. 6A is a perspective schematic view of a multi-mode up-down shade according to another embodiment of the present disclosure, and the level of the falling element is aligned with the bottom edge of the window.

FIG. 6B is a side view of the multi-mode up-down shade shown in FIG. 6A.

FIG. 7A is a perspective schematic view of a multi-mode up-down shade according to yet another embodiment of the present disclosure, and the positioning elements are in the locked position.

FIG. 7B is a perspective schematic view of the multi-mode up-down shade shown in FIG. 7A in another state, and the positioning elements are in the unlocked position.

FIG. 8 is a structure view of a multi-mode up-down shade according to one embodiment of the present disclosure.

FIG. 9A is a partial structure view of a multi-mode up-down shade according to another embodiment of the present disclosure.

FIG. 9B is a partial structure view of a multi-mode up-down shade according to yet another embodiment of the present disclosure.

FIG. 10 is a partial structure view of a multi-mode up-down shade according to yet another embodiment of the present disclosure.

FIG. 11A is a perspective schematic view of a multi-mode up-down shade according to yet another embodiment of the present disclosure, wherein the shade is in an only lower light-transmitting state, and the positioning elements and the falling element are located at a stopping position at a certain preset height between the upper and lower extreme positions.

FIG. 11B is a side schematic view of the multi-mode up-down shade shown in FIG. 11A.

FIG. 12 is a perspective schematic view of the multi-mode up-down shade shown in FIG. 11A, wherein the shade is in a full light-tight state, and the positioning elements the falling element are located at the lower extreme position.

FIG. 13A is a perspective schematic view of the multi-mode up-down shade shown in FIG. 11A, wherein the shade is in an only upper light-transmitting state, the positioning elements are located at a stopping position at a certain preset height between the upper and lower extreme positions, and the falling element is located at the bottom edge of the window.

FIG. 13B is a side schematic view of the multi-mode up-down shade shown in FIG. 13A.

FIG. 14 is a perspective schematic view of the multi-mode up-down shade shown in FIG. 11A, wherein the shade is in an upper and lower simultaneous light-transmitting, middle light-tight state, the positioning elements are located at a stopping position at a certain preset height between the upper and lower extreme positions, and the falling element is located at a certain position between the stopping position and the bottom edge of the window.

FIG. 15 is a perspective schematic view of a multi-mode up-down shade according to yet another embodiment of the present disclosure, wherein the shade is in an upper interval light-transmitting state, and the positioning elements and the falling element are located at a stopping position at a certain preset height between the upper and lower extreme positions.

FIG. 16A is a perspective schematic view of the multi-mode up-down shade shown in FIG. 15, wherein the shade is in another upper interval light-transmitting state, the positioning elements are located at a stopping position at a certain preset height between the upper and lower extreme positions, and the falling element is located at a certain position between the stopping position and the bottom edge of the window.

FIG. 16B is a perspective schematic view of the multi-mode up-down shade shown in FIG. 15, wherein the window is in an upper interval light-transmitting, middle light-tight, lower light-transmitting state, and the locations of the positioning elements and the falling element are the same as those in FIG. 16A.

FIG. 17 is a perspective schematic view of the multi-mode up-down shade shown in FIG. 15, wherein the shade is in a full interval light-transmitting state, the positioning elements and the falling element are located at the bottom edge of the window.

FIG. 18A is a perspective schematic view of the multi-mode up-down shade shown in FIG. 15, wherein the shade is in another full interval light-transmitting state, the positioning elements are located at a stopping position at a certain preset height between the upper and lower extreme positions, and the falling element is located at the bottom edge of the window.

FIG. 18B is a perspective schematic view of the multi-mode up-down shade shown in FIG. 15, wherein the window is in an upper interval light-transmitting, lower light-tight state, and the locations of the positioning elements and the falling element are the same as those in FIG. 18A.

FIG. 19 is a perspective schematic view of the multi-mode up-down shade shown in FIG. 15, wherein the shade is in a full light-tight state, and the positioning elements are located at the upper extreme position, and the falling element is located at the bottom edge of the window.

FIG. 20 is a schematic structural view of a sliding channel and a positioning element in the multi-mode up-down shade shown in FIGS. 11A and 15.

FIG. 21 is a schematic structural view of the multi-mode up-down shade shown in FIGS. 11A and 15, which schematically shows the main structure of the upper part of the shade.

FIG. 22 is a schematic structural view of the multi-mode up-down shade shown in FIGS. 11A and 15, which schematically shows the main structure of the lower part of the shade.

### REFERENCE NUMERALS IN THE DRAWINGS

100, multi-mode up-down shade; 20, winding component; 21, support element; 22, roller; 23, adjusting string; 24, shielding member; 30, cord fabric; 31, light-transmitting section 31; 32, light-tight section 32; 320, double-layer structure; 321, end edge; 301, junction; 40, adjusting rod; 41, end; 42, penetrating slot; 50, positioning element; 50a, first positioning element; 50b, second positioning element; 51, semi-open space; 511, side displacement limiting boundary surface; 512, descent limiting boundary surface; 52, guiding groove; 53, lifting lug; 60, falling element; 61, falling body; 611, groove; 612, width-limiting boundary surface; 62a/62b, rolling contact element; 621, rod-shaped component; 63, falling reel; 64, contact reel; 65, connecting member; 900, window; 901, top edge; 902, bottom edge; 903, installation surface; F1, stretching direction; S1, lowering path; 70, sliding channel; 71, guiding rib; 80, traction assembly; 81, traction reel; 82, flexible traction member; 83, traction string.

### DESCRIPTION OF EMBODIMENTS

Technical solutions of the present disclosure are described clearly and completely below in conjunction with accompanying drawings, apparently, described embodiments are only part of the embodiments of the present disclosure, not all of the embodiments. Based on the embodiments of the present disclosure, all other embodiments obtained by those of ordinary skill in the art without creative work are within a protection scope of the present disclosure.

In the description of the present disclosure, it should be noted that the orientation or positional relationship indicated by the terms “center”, “up”, “down”, “left”, “right”, “vertical”, “horizontal”, “inside”, “outside” and the like is based on the orientation or positional relationship shown in the accompanying drawings, which is only for the convenience of describing the present disclosure and simplifying the description, rather than indicating or suggesting that a device or a component referred to must have a specific orientation and be constructed and operated in a specific orientation, and therefore the terms cannot be understood as limiting the present disclosure. Furthermore, the terms “first”, “second” and “third” are just used for descriptive purposes, and cannot be understood as indicating or implying relative importance.

In the description of the present disclosure, it should be noted that unless otherwise expressly specified or limited, the terms “installed”, “mounted”, “be connected” and “connect” should be understood in a broad sense, for example, it may be a fixed connection, it may also be a detachable connection, or an integrated connection; it may be a mechanical connection, or alternatively an electrical connection; it may be a direct connection, it may also be an indirect connection through an intermediate element; alternatively, it may be an internal communication between two components. For those of ordinary skill in the art, specific meanings of the above terms in the present disclosure can be understood according to specific situations.

The technical solutions provided by the embodiments of the present disclosure are described below in conjunction with the accompanying drawings.

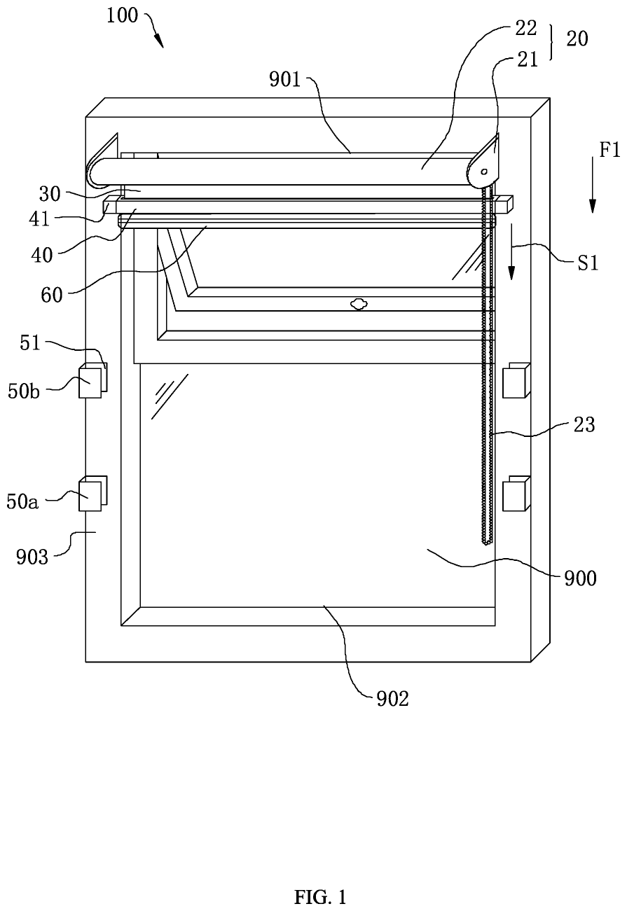

Referring to FIG. 1, a multi-mode up-down shade 100 is provided by the present disclosure, the multi-mode up-down shade 100 is capable of entirely or partially shading a window 900 in an adjustable manner, thereby completely or partially shading natural light entering a room from the window 900, to adjust a brightness of the room; and thus a shading degree of the multi-mode up-down shade 100 on the window 900 can be adjusted as needed, to protect indoor privacy. Specifically, the window 900 can be a floor-to-ceiling window 900, or a window with a bottom edge 902 located above the ground on a same floor with a height difference there between.

Specifically, the window 900 described in the present disclosure includes not only one or more holes on an opaque wall in a traditional sense that at least allow outdoor light to enter the room (the holes may also allow both the outdoor light and air to enter the room), but also a transparent or translucent wall in a modern sense. The transparent or translucent wall is a device that allows the outdoor light to enter the room, and is mainly composed of a single piece or a plurality of pieces of transparent or translucent glass and is equipped with a supporting frame. That is, no matter whether there are the holes in the wall, as long as there exists a light-transmitting part, the light-transmitting part falls within a scope of the window of the present disclosure.

In some embodiments, the window 900 can be understood as a building structure with an opening. The opening can be understood as the holes that at least allow the outdoor light to enter the room (the holes may also allow the outdoor light and air to enter the room at the same time). A boundary of the opening of the window 900 is formed by the wall. In some other embodiments, the boundary of the opening of the window 900 is formed by a metal or plastic frame. A support element 21 is installed on a wall or a metal frame. In some further embodiments, the boundary of the opening of the window 900 can be formed by glass or other rigid materials. Specifically, a height dimension of the window 900 can be understood as a measurement between a top edge 901 and the bottom edge 902 of the window 900.

In some embodiments, the opening of the window 900 is at least light-transmitting. Furthermore, the opening of the window 900 can also be air-permeable. In some embodiments, the opening of the window 900 is completely open and is not shaded by a light-transmitting and wind-blocking structure, and therefore the window 900 has both light transmittance and air permeability.

In some embodiments, the opening of the window 900 is shaded by the light-transmitting and wind-blocking structure, and the window 900 is light-transmitting but not air-permeable. A material of the light-transmitting and wind-blocking structure may include glass, acrylic or other translucent materials. In some other embodiments, the opening of the window 900 can also be understood as a local light-transmitting area in a single piece of glass, and areas other than the local light-transmitting area can be light-tight by applying film, painting, glass dyeing, or the like.

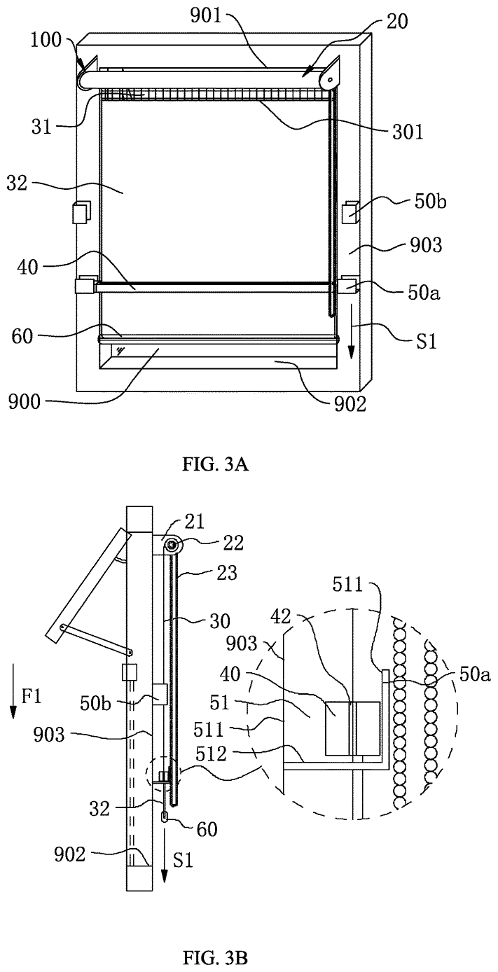

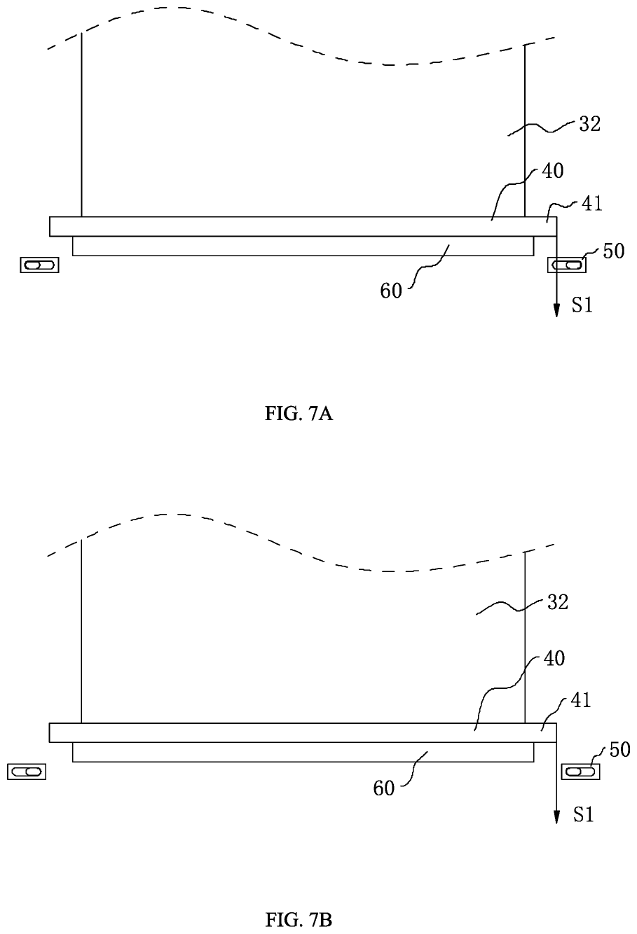

In some embodiments, as shown in FIG. 3A, FIG. 3B and FIG. 7A, the multi-mode up-down shade 100 includes a winding component 20, a cord fabric 30, an adjusting rod 40, at least one pair of positioning elements 50, and a falling element 60. The winding component 20 includes a support element 21 and a roller 22 rotatably mounted on the support element 21. The cord fabric 30 is made of flexible fabric and can be completely or partially wound around an outer periphery of the roller 22.

The cord fabric 30 includes a light-transmitting section 31 and a light-tight section 32. The light-transmitting section 31 and the light-tight section 32 are connected one another along a stretching direction F1 of the cord fabric 30. The light-tight section 32 is arranged in front of the light-transmitting section 31 along the stretching direction F1. When the cord fabric 30 is completely deployed, the light-transmitting section 31 is located above the light-tight section 32. Preferably, a length of the light-tight section 32 along the stretching direction F1 is slightly greater than an overall height of the opening of the window 900, therefore the opening of the window 900 can be completely covered by the light-tight section 32. A length of the light-transmitting section 31 can be determined according to needs, for example, the length of the light-transmitting section 31 can be ⅓, ½, or ¾ of the length of the light-tight section 32, which can be determined according to actual conditions.

The light-tight section 32 is made of light-impervious fabric. The light-transmitting section 31 can be formed by light-transmitting fabric, or can be formed by providing one or more hollow portions on the cord fabric 30.

The adjusting rod 40 is fixedly connected to an end of the light-tight section 32 (that is, one end of the light-tight section 32 away from the light-transmitting section 31), and the adjusting rod 40 is lifted and lowered together with the light-tight section 32 when the cord fabric 30 is lifted and lowered. Before the adjusting rod 40 is positioned on the positioning elements (the positioning elements 50 as shown in FIG. 7A, the first positioning elements 50a or the second positioning element 50b as shown in FIG. 1), the adjusting rod 40 is arranged at an interval from the light-transmitting section 31 along the stretching direction F1 of the cord fabric 30. A middle part of the light-tight section 32 slidably extends through a penetrating slot 42 of the adjusting rod 40. As the cord fabric 30 lifts and lowers, the adjusting rod 40 can move up and down along a lowering path S1, and the lowering path S1 has an upper extreme position and a lower extreme position. The light-tight section 32 forms a double-layer structure 320 below the adjusting rod 40.

At least one pair of positioning elements is mounted beside the window 900, specifically, the two positioning elements of each pair are symmetrically arranged on two sides of the window respectively. The pair of positioning elements is located between the upper extreme position and the lower extreme position of the lowering path S1 of the adjusting rod 40, to interact with the adjusting rod 40. The positioning elements are movable between a locked position and an unlocked position. When the positioning elements are in the locked position, the positioning elements are interfered with the lowering path S1 of the adjusting rod 40, at this time, the adjusting rod 40 will be stopped by the positioning elements, to prevent the adjusting rod 40 from further lowering. When the positioning elements are in the unlocked position, the positioning elements are free of interfering with the lowering path S1 of the adjusting rod 40, at this time, the adjusting rod 40 can smoothly lower downwardly over the positioning elements to a position below the positioning elements. In the present disclosure, a position aligned with the level of the positioning elements is defined as a stopping position.

In some embodiment, as shown in FIG. 3A and FIG. 3B, the multi-mode up-down shade 100 is provided with a pair of first positioning elements 50a located at a same level and a pair of second positioning elements 50b located at a same level. The first positioning element pair 50a and the second positioning element pair 50b are located at different height levels, and the first positioning element pair 50a are located below the second positioning elements 50b.

The falling element 60 is slidably connected to a part of the light-tight section 32 between the penetrating slot 42 of the adjusting rod 40 and the end of the light-tight section 32.

When the cord fabric 30 is lifted, the falling element 60 slides to an end edge 321 of the light-tight section 32 due to its weight. Since the end edge 321 of the light-tight section 32 is connected to the adjusting rod 40, the falling element 60 will not fall off from the cord fabric 30, and at this time, the adjusting rod 40 also slides relative to the light-tight section 32 until it abuts against the falling element 60 and then the adjusting rod 40 will move upwardly together with the cord fabric 30.

When the cord fabric 30 is lowered downwardly and the positioning elements are in the unlocked position, the adjusting rod 40 can smoothly pass the stopping position. When the positioning elements are in the locked position, the adjusting rod 40 will be positioned at the stopping position, that is, the adjusting rod 40 will be positioned at the positioning elements, and at this time, the falling element 60 can continue to lower. As the cord fabric 30 continues to lower, the light-tight section 32 also continues to lower. However, since the end edge 321 of the light-tight section 32 is fixedly connected to the adjusting rod 40, and the middle part of the light-tight section 32 slides through the adjusting rod 40, a part of the light-tight section 32 located on a lower side of the adjusting rod 40 is folded into the double-layer structure 320. It can be understood that as a lowering displacement amount of the cord fabric 30 varies, a length of the double-layer structure 320 along the vertical direction changes. However, regardless of how the lowering displacement amount of the cord fabric 30 changes, since the falling element 60 is slidably connected at the double-layer structure 320 and under an action of its own weight, the falling element 60 is always located at the bottom end of the double-layer structure 320.

In one embodiment, the double-layer structure 320 serves to hang or bear all or part of the falling element 60.

Specifically, as shown in FIG. 1, the roller 22 is installed adjacent to the top edge 901 of the window 900 through the support elements 21. The roller 22 can be rotated relative to the support elements 21 to a predetermined angle under traction. When the roller 22 is rotated in a direction of winding up the cord fabric 30, a length of the cord fabric 30 wound around the outer periphery of the roller 22 is increased. Since the light-tight section 32 is arranged in front of the light-transmitting section 31 along the stretching direction F1, the light-tight section 32 begins to be wound around the outer periphery of the roller 22 until the light-transmitting section 31 has been completely wound around the outer periphery of the roller 22.

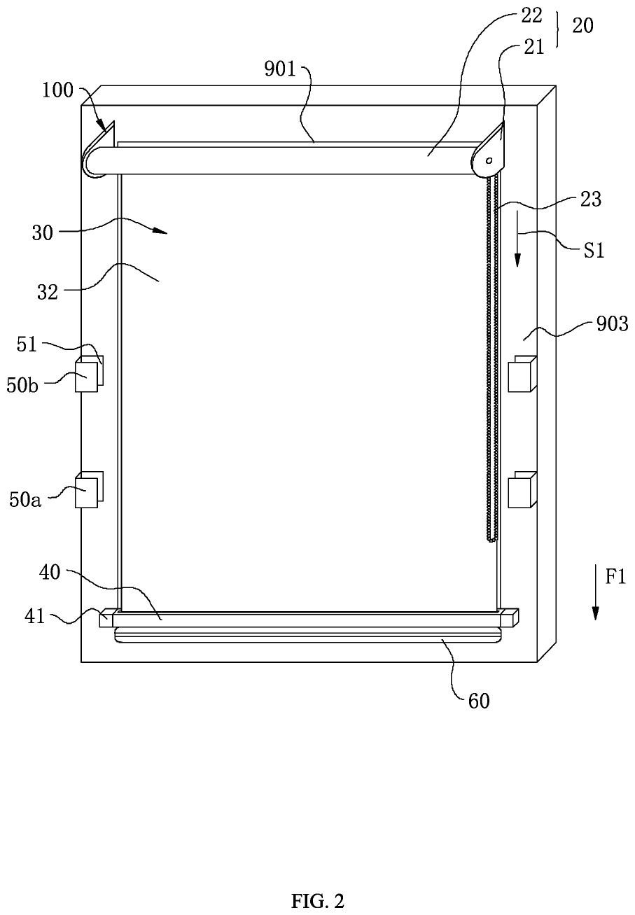

As shown in FIG. 2, in the deployed state, a length of the light-tight section 32 along the stretching direction F1 is slightly longer than the height dimension of the window 900, therefore, when the light-tight section 32 is completely deployed, the window 900 can be completely covered by the light-tight section 32. When the roller 22 is rotated in a direction of releasing the cord fabric 30, the cord fabric 30 is gradually released from the outer periphery of the roller 22 and unfolded. The cord fabric 30 sags downwardly under the action of gravity. Since the adjusting rod 40 and the falling element 60 are respectively connected to the cord fabric 30, when the roller 22 is rotated in the direction of releasing the cord fabric 30, the adjusting rod 40 and the falling element 60 are lowered accordingly. Since the adjusting rod 40 is fixedly connected to the end of the light-tight section 32, and the falling element 60 is slidably connected to the part of the light-tight section 32 located between the adjusting rod 40 and the end of the light-tight section 32, before the adjusting rod 40 is lowered to contact the positioning elements (the positioning elements 50 as shown in FIG. 7A, the first positioning element 50a, or the second positioning element 50b as shown in FIG. 1), the falling element 60 abuts against the adjusting rod 40, and is lowered together with the light-tight section 32. The positioning elements are installed beside the window 900, and the level of the positioning elements is higher than that of the bottom edge 902 of the window 900.

In the case that the adjusting rod 40 is positioned at the positioning elements, i.e., at the stopping position, and the falling element 60 is at a lower position relative to the adjusting rod 40, and when the roller 22 is rotated in the direction of winding up the cord fabric 30, since the part of the light-tight section 32 connected to the adjusting rod 40 is restricted by the adjusting rod 40, a vertical dimension of the double-layer structure 320 is shortened by means of the rotation of the roller 22, and the falling element 60 is lifted due to restriction by the end of the light-tight section 32 fixedly connected to the adjusting rod 40, until the falling element 60 abuts against the adjusting rod 40 upwardly. Thereafter, when the roller 22 continues to be rotated in the direction of winding up the cord fabric 30, drawn by the light-tight section 32, the adjusting rod 40 is pushed by the falling element 60 to leave the positioning elements and continue to lift.

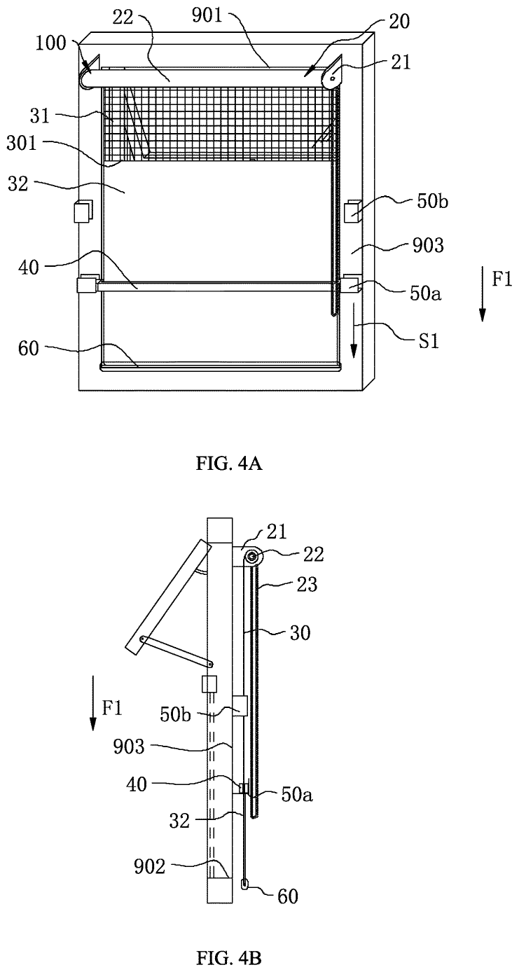

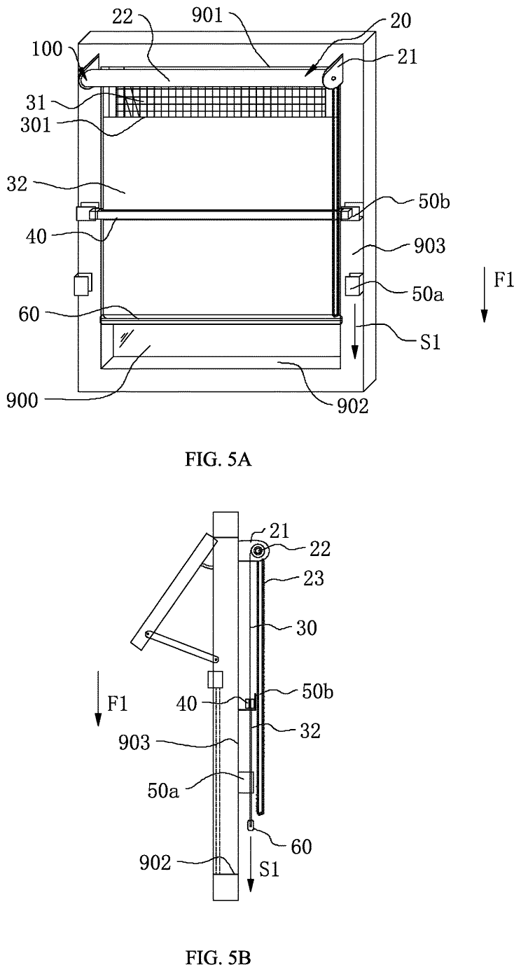

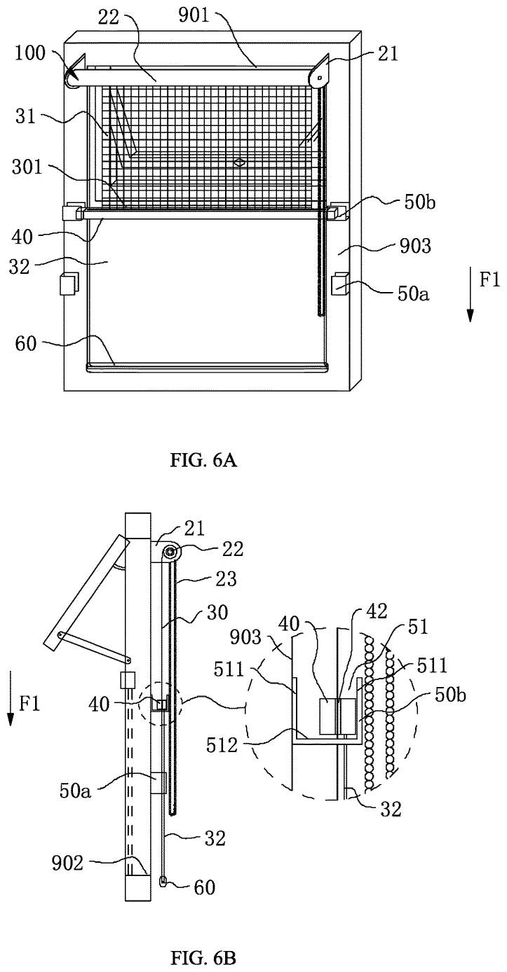

In the case that indoor lighting needs to be met while the indoor privacy needs to be ensured, before the adjusting rod 40 is lowered to the stopping position where the positioning elements are located, one pair of positioning elements (the first positioning element pair 50a as shown in FIG. 3A and FIG. 4A, or the second positioning element pair 50b as shown in FIG. 5A and FIG. 5B and FIG. 6A) can be switched to the locked position, and the lowered adjusting rod 40 is moved to the positioning elements and is stopped by the positioning elements, thereby being positioned at the stopping position. Under a restriction of the positioning elements, the adjusting rod 40 is positioned at a stopping position with a certain height relative to the bottom edge 902 of the window 900, while the falling element 60 slides downwardly as the cord fabric 30 continues to lower. Since the end of the light-tight section 32 is connected to the adjusting rod 40, the end of the light-tight section 32 is also positioned at the stopping position and is no longer lowered, As the cord fabric 30 continues to lower, the upper part of the light-tight section 32 continues to move downwardly and passed through the adjusting rod 40 and sags, thereby folding into the double-layer structure 320 below the adjusting rod 40. The falling element 60 always keep sliding to the bottom of the double-layer structure 320 due to its own weight, and a downward pulling force is applied to the cord fabric 30 due to the weight of the falling element 60, which is not only conducive to the light-tight section 32 to smoothly pass through the adjusting rod 40 during a lowering process of the cord fabric 30, but also ensures a flatness of the cord fabric 30.

Since the length of the light-tight section 32 along the stretching direction F1 is slightly greater than the height dimension of the window 900, when the light-tight section 32 is folded to a certain length in the horizontal direction, the light-transmitting section 31 begins to be released and unfolded. When a junction 301 between the light-transmitting section 31 and the light-tight section 32 is moved to a position lower than the top edge 901 of the window 900, the light-transmitting section 31 is aligned with the upper part of the opening of the window 900. At this time, the outdoor natural light can enter the room through the light-transmitting section 31. Since the remaining part of the opening of the window 900 is still shaded by the light-tight section 32, the needs of indoor privacy protection can be satisfied simultaneously, avoiding requirement of full light-shading of the window 900 when it is needed to ensure the indoor privacy.

A degree of deployment of the light-transmitting section 31 can be determined by users according to the needs for lighting and protecting privacy. As shown in FIG. 3A and FIG. 5A, the light-transmitting section 31 can be partially deployed, at this time, the lower part of the opening of the window 900 is not completely covered by the lower part of the light-tight section 32, and light can be received both through the light-transmitting section 31 above and the exposed opening of the window 900 below. It can also be shown in FIG. 4A and FIG. 6A, the cord fabric 30 is further deployed, to make the lower part of the opening of the window 900 completely be covered by the light-tight section 32, and light is received only through the light-transmitting section 31 above, and thus the indoor privacy can be better protected without affecting lighting.

It can be seen from FIGS. 3A, 4A, 5A, and 6A that when both lighting and better protection of the indoor privacy are required, the first positioning element 50a can be switched to the locked state (as shown in FIGS. 3A and 4A). However, when both indoor privacy protection and better lighting are needed, the second positioning element 50b can be switched to the locked state (as shown in FIGS. 5A and 6A). Users can choose flexibly according to actual needs, in order to get a balance between lighting and privacy protection, to thereby satisfy the users need.

As shown in FIG. 2, when the indoor people needs to sleep, the window 900 can be completely shaded by the multi-mode up-down shade 100 in the full light-tight mode. Before the adjusting rod 40 lowers to the position of the positioning elements (the first positioning element 50a or the second positioning element 50b as shown in FIG. 2), the positioning elements are switched to the unlocked position. The adjusting rod 40 will not be interfered by the positioning elements during the lowering process, so the adjusting rod 40 can be smoothly lowered to the bottom edge 902 of the window 900. Since the length dimension of the light-tight section 32 along the stretching direction F1 is slightly longer than the height dimension of the opening of the window 900, the window 900 can be completely shaded by the light-tight section 32. When the user needs full lighting, he or she only needs to roll the light-transmitting section 31 and the light-tight section 32 of the cord fabric 30 completely around the outer periphery of the roller 22.

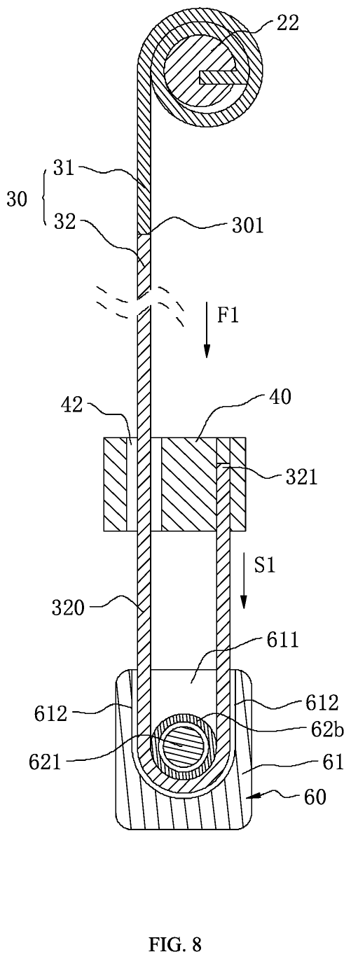

Specifically, as shown in FIG. 4A and FIG. 8, the junction 301 is a transition position between the light-transmitting section 31 and the light-tight section 32.

In some embodiments, as shown in FIG. 1 and FIG. 2, the support elements 21 are provided in a pair. One end of the roller 22 is installed on one of the support elements 21, and the other end of the roller 22 is installed on the other support element 21. In some embodiments, a level of the roller 22 is slightly higher than that of the top edge 901 of the window 900. Thus, when the window 900 is completely shaded by the light-tight section 32, undesired light leakage through a gap between the top edge 901 of the window 900 and the light-tight section 32 can be avoided.

In some embodiments, in order to avoid the roller 22 rotating along the direction of releasing due to the gravity of the falling element 60, damped rotation of the roller 22 is provided. In some embodiments, as shown in FIG. 1, the roller 22 is rotated under the traction of an adjusting string 23, and when the adjusting string 23 is released from being pulled, the roller 22 is positioned at a stable angle.

In some embodiments, the cord fabric 30 can be made of flame-retardant fabric.

In some embodiments, the light-transmitting section 31 can be provided with a light-transmitting area and a light-impervious area, the outdoor natural light can pass through the light-transmitting area, and an area of the light-transmitting area of the light-transmitting segment 31 may be greater than an area of the light-impervious area. In some embodiments, the light-transmitting section 31 can also be formed by one or more hollow portions on light-impervious fabrics. In some embodiments, as shown in FIG. 5A and FIG. 6A, the light-transmitting section 31 is made of meshed fabric.

In some embodiment, light transmittance of the light-transmitting section 31 is greater than light transmittance of the light-tight section 32. In some embodiment, weaving density of the light-transmitting section 31 is smaller than weaving density of the light-tight section 32. In some embodiments, the light-transmitting section 31 is made of a transparent material or a semi-transparent material, and the light-tight section 32 is made of the semi-transparent material or a non-transparent material.

In some embodiments, as shown in FIG. 3A to FIG. 4B, the first positioning elements 50a and the second positioning elements 50b are rotatably arranged, therefore, they can be switched between the locked position and the unlocked position. Specifically, the first positioning elements 50a and the second positioning elements 50b can be installed on an installation surface 903 adjacent to the window 900 through a rotating shaft. When the first positioning element 50a is rotated about the rotating shaft component, it will be switched between the locked position and the unlocked position.

As shown in FIG. 5A to FIG. 6B, in some embodiments, a semi-open space 51 is defined by the positioning elements (the first positioning elements 50a or the second positioning elements 50b as shown in FIGS. 6A and 6B) that has an opening, and the opening orientation can be adjusted by rotating the position elements. Specifically, when the positioning elements are in the unlocked position, the adjusting rod 40 can freely pass through the semi-open space 51. In the case that the positioning elements are in the locked position, when the adjusting rod 40 is lowered to the level of the positioning elements, the adjusting rod 40 is blocked by at least one boundary surface of the semi-open space 51, and thus the adjusting rod 40 is positioned at the level of the positioning elements, i.e., the stopping position. In this embodiment, as shown in FIG. 6B, a shape of a cross section of the second positioning element 50b is substantially U-shaped.

In some embodiments, as shown in FIG. 3B, the semi-open space 51 with the opening orientation that can be adjusted by rotation is defined by the positioning elements (the first positioning elements 50a or the second positioning elements 50b as shown in FIGS. 3A and 3B) and the installation surface 903 cooperatively. Specifically, when the positioning elements are in the unlocked position, the adjusting rod 40 can freely pass through a gap between the positioning elements and the installation surface 903. In this embodiment, as shown in FIG. 3B, a shape of a cross section of the first positioning element 50a is substantially L-shaped.

In some embodiments, as shown in FIG. 3B and FIG. 6B, the at least one boundary surface of the semi-open space 51 includes two side displacement limiting boundary surface 511 and a descent limiting boundary surface 512. The two side displacement limiting boundary surfaces 511 are arranged opposite to each other. The descent limiting boundary surface 512 is arranged between the two side displacement limiting boundary surfaces 511. In some embodiments, as shown in FIG. 3B, in the case that the first positioning elements 50a are in the locked position and the adjusting rod 40 is accommodated in the semi-open space 51, the adjusting rod 40 abuts against the descent limiting boundary surface 512, thereby limiting the lowering of the adjusting rod 40. In a horizontal direction perpendicular to the length direction of the adjusting rod 40, movement of the adjusting rod 40 in the horizontal direction is limited by the side displacement limiting boundary surfaces 511, so that the adjusting rod 40 can be stabilized in the semi-open space 51. In some embodiments, as shown in FIG. 2 and FIG. 3B, when the second positioning element 50b is in the unlocked position, the side displacement limiting boundary surfaces 511 and the descent limiting boundary surface 512 are all perpendicular to the horizontal plane, and the descent limiting boundary surface 512 is away from a center of the adjusting rod 40 than the side displacement limiting boundary surface 511, therefore, the adjusting rod 40 can pass through the semi-open space between the two opposite side displacement limiting boundary surfaces 511.

In some embodiments, as shown in FIG. 6B, in the case that the positioning elements (the first positioning element 50a or the second positioning element 50b as shown in FIG. 6A and FIG. 6B) are provided with the semi-open space 51, the side displacement limiting boundary surface 511 and the descent limiting boundary surface 512 are formed merely by the second positioning element 50b. In some other embodiments, as shown in FIG. 3B, in the case that the semi-open space 51 is defined by the positioning elements (the first positioning element 50a or the second positioning element 50b as shown in FIG. 3A and FIG. 3B) and the installation surface 903 together, one side displacement limiting boundary surface 511 is formed by the installation surface 903, and the other side displacement limiting boundary surface 511 and the descent limiting boundary surface 512 are formed by the first positioning element 50a. As shown in FIG. 2, in the case that the positioning elements (the first positioning element 50a or the second positioning element 50b as shown in FIG. 2) are in the unlocked position, an end 41 of the adjusting rod 40 passes through the semi-open space 51. Since a length of the end 41 of the adjusting rod 40 is small, the semi-open space 51 only needs to be provided for the end 41 of the adjusting rod 40 to pass through, thereby reducing a volume requirement of the semi-open space 51.

In some embodiments, as shown in FIG. 7A and FIG. 7B, the positioning elements 50 are slidably disposed between the locked position and the unlocked position. In some embodiments, the positioning elements 50 can be installed on the installation surface 903 adjacent to the window 900 through a guide component, such as a guide rail. The positioning element 50 is in sliding fit with the guide component. In some embodiments, the positioning element 50 is slidably disposed between the locked position and the unlocked position along the horizontal direction. Specifically, since an orientation of the positioning element 50 is limited by the guide component, the positioning element 50 is kept at a stable angle when sliding between the locked position and the unlocked position, therefore, the positioning elements 50 can support the adjusting rod 40 in the locked position. In some embodiments, a sliding direction of the positioning element 50 may be parallel to a length direction of the adjusting rod 40. In some other embodiments, the sliding direction of the positioning element 50 may be perpendicular to the installation surface 903, by providing an insertion space for the positioning element 50 on the installation surface 90.

In some embodiments, as shown in FIG. 7A and FIG. 7B, the positioning elements 50 are provided in pairs. Each pair of positioning elements 50 interferes with the lowering path S1 of two ends 41 of the adjusting rod 40 when in the locked position. Specifically, in the case of that the positioning element 50 is in the locked position, one end 41 of the adjusting rod 40 is supported by one positioning element 50 of a pair, and the other end 41 is supported by another positioning element 50 of the pair, thereby providing more stable support for the adjusting rod 40 and preventing the adjusting rod 40 from tilting and sliding downwardly.

In some embodiments, as shown in FIG. 7A and FIG. 7B, the two positioning elements 50 of a same pair are arranged at a same height level. In some embodiments, a horizontal distance between the two positioning elements 50 at the unlocked position is not less than the horizontal length of the adjusting rod 40, therefore, interference between the positioning elements 50 at the unlocked position and the lowering path S1 of the adjusting rod 40 can be avoided, and the adjusting rod 40 can be lowered and pass through the space between the two positioning elements 50. In some embodiments, the length direction of the adjusting rod 40 and the length direction of the falling element 60 are parallel to the horizontal direction respectively. The length of the falling element 60 is smaller than the length of the adjusting rod 40, to avoid the falling of the falling element 60 being affected by the positioning elements 50. In some embodiments, a distance between the two positioning elements 50 of a pair in the locked position is greater than the length of the falling element 60.

In some embodiments, as shown in FIG. 1 and FIG. 2, at least two pairs of positioning elements are provided and distributed at different height levels along the lowering path S1 of the adjusting rod 40. Specifically, the at least two pairs of positioning elements are distributed at different stopping positions along the lowering path S1 of the adjusting rod 40, and as shown in FIG. 2, when all the positioning elements are in the unlocked position, the window 900 can be completely shaded by the light-tight section 32. As shown in FIG. 3A and FIG. 5A, the adjusting rod 40 can be stopped from lowering at a corresponding height level, by adjusting one pair of positioning elements to the locked position and the other positioning elements to the unlocked position, therefore, the light-tight section 32 can be formed into different folding states, or the junction 301 between the light-tight section 32 and the light transmitting section 31 can be positioned at different heights.

In some embodiments, a height distance between one pair of positioning elements (the first positioning element 50a as shown in FIGS. 3A and 4A) and the bottom edge 902 of the window 900 is about 20% to 30% of the height dimension of the window 900. Specifically, as shown in FIG. 3A to FIG. 4B, a height distance between the pair of the first positioning elements 50a and the bottom edge 902 of the window 900 is about 25% of the height dimension of the window 900. The height dimension of the window 900 is defined as L, when the first positioning elements 50a are in the locked position, the adjusting rod 40 is positioned at a height level of the first positioning elements 50a, in the case that a lowering displacement of the falling element 60 relative to the adjusting rod 40 is greater than

$$\frac{1}{8} L$$

and less than

$$\frac{1}{4} L ,$$

since the height level of the falling element 60 is higher than the bottom edge 902 of the window 900, a small lighting or ventilation space can be formed between the falling element 60 and the bottom edge 902 of the window 900 in the height direction, which will not significantly affect the indoor privacy. In the case that the lowering displacement of the falling element 60 relative to the adjusting rod 40 is greater than

$$\frac{1}{8} L$$

and less than

$$\frac{1}{4} L ,$$

since the length of the light-tight section 32 along the stretching direction F1 is about L, a height level of the junction 301 is lower than the top edge 901 of the window 900, and a distance between the junction 301 and the top edge 901 of the window 900 in the height direction is greater than zero and less than

$$\frac{1}{4} L .$$

The light-transmitting section 31 is located between the top edge 901 of the window 900 and the junction 301 in the height direction, therefore, the outdoor natural light can enter the room through the light-transmitting section 31.

As shown in FIG. 3A, in the case that the lowering displacement of the falling element 60 relative to the adjusting rod 40 is equal to

$$\frac{1}{6} L ,$$

the falling element 60 is located above the bottom edge 902 of the window 900 by a distance of

$$\frac{1}{12} L .$$

The junction 301 is located below the top edge 901 of the window 900 by a distance of

$$\frac{1}{12} L ,$$

therefore, two light-transmitting areas are formed in the upper and lower parts of the window 900 respectively, and height dimensions of the two light-transmitting areas are equal and are both

$$\frac{1}{12} L .$$

One of the two light-transmitting areas is adjacent to the top edge 901 of the window 900, and the other light-transmitting area is adjacent to the bottom edge 902 of the window 900, therefore, the middle of the window 900 can still remain shaded by a relatively large area.

As shown in FIG. 4A, in the case that the lowering displacement of the falling element 60 relative to the adjusting rod 40 is equal to

$$\frac{1}{4} L ,$$

the height level of the falling element 60 is aligned with the height level of the bottom edge 902 of the window 900, that is, the lower part is completely shaded, while a distance between the upper junction 301 and the top edge 901 of the window 900 in the height direction is

$$\frac{1}{4} L ,$$

therefore, one quarter of the area of the upper part of the window 900 is aligned with the light-transmitting part, and the outdoor natural light can be penetrated.

In some embodiments, the height distance between one pair of positioning elements (the second positioning element 50b as shown in FIGS. 5A and 6A) and the bottom edge 902 of the window 900 is 40% to 60% of the height dimension of the window 900. Specifically, as shown in FIG. 5A to FIG. 6B, a height distance between the second positioning elements 50b and the bottom edge 902 of the window 900 is 50% of the height dimension of the window 900. In some embodiments, when the second positioning elements 50b are in the locked position, the adjusting rod 40 is positioned at a height level of the second positioning element 50b, in the case that the lower displacement of the falling element 60 relative to the adjusting rod 40 is greater than

$$\frac{1}{4} L$$

and less than

$$\frac{1}{2} L ,$$

since the height level of the falling element 60 is higher than the bottom edge 902 of the window 900, a small lighting or ventilation space will be formed between the falling element 60 and the bottom edge 902 of the window 900 in the height direction, and at the same time, a certain degree of privacy is protected indoors. The height level of the junction 301 is lower than the top edge 901 of the window 900, and the distance between the junction 301 and the top edge 901 of the window 900 in the height direction is greater than zero and less than

$$\frac{1}{2} L .$$

The light-transmitung section 31 is located between the top edge 901 of the window 900 and the junction 301 in the height direction, therefore, the outdoor natural light can enter the room through the light-transmitting section 31.

As shown in FIG. 5A, in the case that the lowering displacement of the falling element 60 relative to the adjusting rod 40 is equal to

$$\frac{1}{3} L ,$$

the falling element 60 is located above the bottom edge 902 of the window 900 by a distance of

$$\frac{1}{6} L .$$

The junction 301 is located below the top edge 901 of the window 900 by a distance of

$$\frac{1}{6} L ,$$

therefore, two light-transmitting areas are formed in the upper and lower parts of the window 900 respectively, and the height dimensions of the two light-transmitting areas are equal and are both

$$\frac{1}{6} L .$$

One of the two light-transmitting areas is adjacent to the top edge 901 of the window 900, and the other light-transmitting area is adjacent to the bottom edge 902 of the window 900, therefore, the middle of the window 900 remains shaded by a relatively small area.

As shown in FIG. 6A, in the case that the lowering displacement of the falling element 60 relative to the adjusting rod 40 is equal to

$$\frac{1}{2} L ,$$

the height level of the falling element 60 is aligned with the height level of the bottom edge 902 of the window 900, at the same time, the lower part of the window 900 is completely shaded, and the distance between the junction 301 of the cord fabric 30 and the top edge 901 of the window 900 in the height direction is

$$\frac{1}{2} L ,$$

therefore, one-half of the area of the window is aligned with the light-transmitting part, and more outdoor natural light can be penetrated.

In some embodiments, as shown in FIG. 8, a width of the penetrating slot 42 is greater than a thickness of the light-tight section 32. The falling element 60 is slidably disposed between the end edge 321 of the light-tight section 32 away from the light transmitting section 31 and the penetrating slot 42. Specifically, a width direction of the penetrating slot 42 is perpendicular to the length direction of the adjusting rod 40, and is substantially parallel to the horizontal plane. In some embodiments, the width of the penetrating slot 42 is about 3 mm.

Limited by a size of the penetrating slot 42, the falling element 60 cannot pass through the penetrating slot 42, and the falling element 60 is limited to one side of the adjusting rod 40. When the adjusting rod 40 is supported by the positioning elements (the first positioning elements 50a and the second positioning elements 50b as shown in FIG. 2, or the positioning elements 50 in FIG. 7A), the falling element 60 is located below the adjusting rod 40. In some embodiments, the falling element 60 is slidably surrounding an outer periphery of the light-tight section 32.

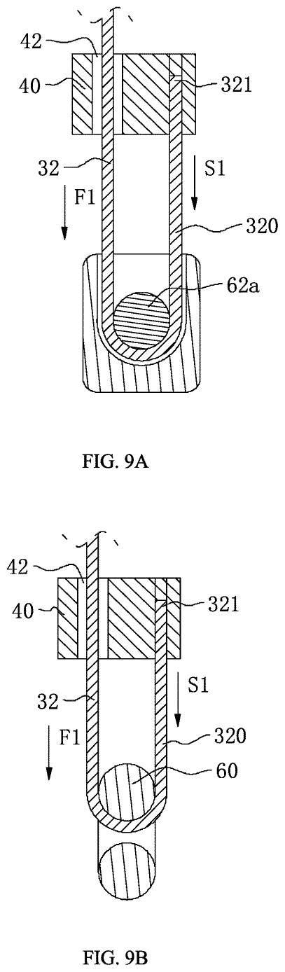

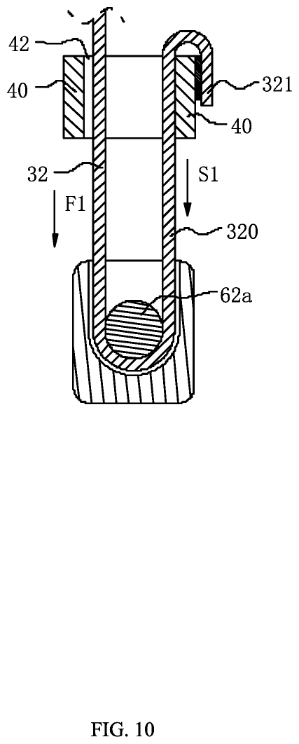

In some embodiments, as shown in FIG. 10, a structure folded inside and outside the adjusting rod 40 is formed by the end of the light-tight section 32, and this part of the light-tight section 32 is in a form of being hooked on the adjusting rod 40 in cross section. In some embodiments, a part of the end of the light-tight section 32 is bonded with an outer side surface of the adjusting rod 40. In some embodiments, as shown in FIG. 9A and FIG. 9B, the end of the light-tight section 32 away from the light transmitting section 31 is fixedly clamped in the adjusting rod 40. In some other embodiments, the end edge 321 of the light-tight section 32 away from the light transmitting section 31 is fixedly connected to the adjusting rod 40 by nails or other fasteners.

In some embodiments, as shown in FIG. 8 and FIG. 9A, the falling element 60 includes a falling body 61 and a rolling contact element 62a rotatably connected to the falling body 61. The light-tight section 32 is movably threaded between the rolling contact element 62a and the falling body 61. In some embodiments, a weight of the falling body 61 is greater than a weight of the rolling contact element 62a. In the case that the roller 22 is rotated in the direction of releasing the cord fabric 30, and the adjusting rod 40 is loaded on the positioning elements, as the cord fabric 30 lowers, the falling element 60 slides downwardly under the action of gravity, and parts of the light-tight section 32 are threaded between the rolling contact element 62a and the falling body 61 in sequence to reach the other side of the rolling contact element 62a. As the light-tight section 32 is rotated around the outer periphery of the rolling contact element 62a, the rolling contact element 62a is rotated relative to the falling body 61 driven by the light-tight section 32, therefore, a rolling friction fit is formed between the rolling contact element 62a and the cord fabric 30, thereby reducing friction between the rolling contact element 62a and the cord fabric 30, and increasing duration of the cord fabric 30. In some embodiment, in the case that the light-tight section 32 is folded in the horizontal direction, the rolling contact element 62a is loaded on the light-tight section 32, and the falling body 61 is suspended below the light-tight section 32 through the rolling contact element 62a.

In some embodiments, as shown in FIG. 9A, the rolling contact element 62a is rod-shaped and is rotatably inserted into the falling body 61. In some embodiments, a bearing is provided between an end 41 of the rolling contact element 62a and the falling body 61. In some embodiments, as shown in FIG. 8, the rolling contact element 62a is sleeve-shaped and is rotatably mounted around an outer periphery of a rod-shaped component 621, and the rod-shaped component 621 is connected to the falling body 61.

In some embodiments, as shown in FIG. 8 and FIG. 9A, a recessed groove 611 is formed in the falling body 61. The rolling contact element 62a is accommodated in the groove 611. The groove 611 is formed between two width-limiting boundary surfaces 612 of the falling body 61. A distance between the two width-limiting boundary surfaces 612 is greater than an outer diameter of the rolling contact element 62a. Specifically, the width-limiting boundary surfaces 612 and the rolling contact element 62a are spaced apart from each other. Since the rolling contact element 62a is in the groove 611, when the light-tight section 32 is wound and passes through the outer periphery of the rolling contact element 62a, a distance between two overlapping parts of the light-tight section 32 in the horizontal direction is limited by the two width-limiting boundary surfaces 612. Therefore, a spacing between the two overlapping parts of the light-tight section 32 in the horizontal direction can be reduced, thereby making the cord fabric 30 more flat, helping the cord fabric 30 to maintain an excellent shape conforming the window 900, and ensuring the light-tight section 32 conforming the side of the window 900. In some embodiments, an opening of the groove 611 is formed between outer boundaries of the two width-limiting boundary surfaces 612.

In some embodiments, as shown in FIG. 9B, the falling element 60 is a single piece of a ring shape and surrounds the outer periphery of the light-tight section 32. Specifically, a sliding friction fit is formed between the falling element 60 and the surface of the light-tight section 32.

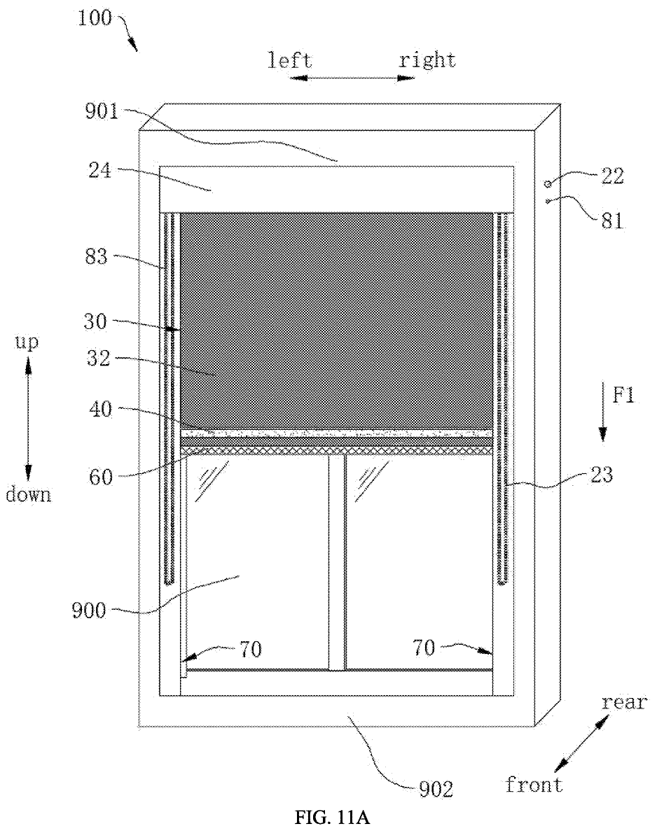

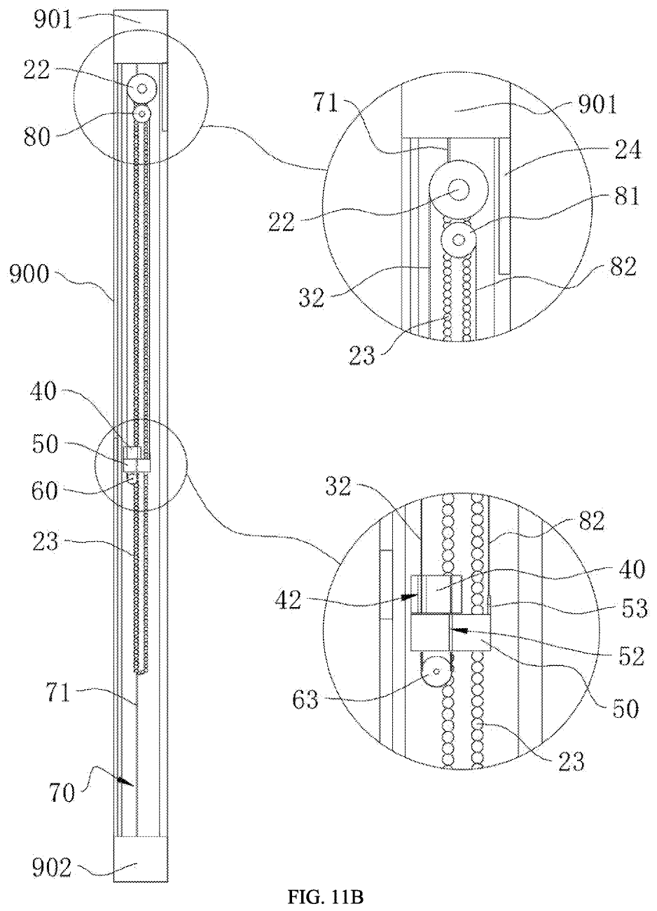

In addition to the embodiments shown in FIGS. 1 to 10, the present disclosure further provides another multi-mode up-down shade 100 to further improve the user experience. Referring to FIGS. 11A and 11B, the multi-mode up-down shade 100 includes a roller 22, a cord fabric 30, an adjusting rod 40, a pair of positioning elements 50, and a falling element 60. The main difference between this embodiment and the embodiment shown in FIGS. 1 to 10 is that the shade is configured with only one pair of positioning elements 50, and the pair of positioning elements 50 is configured to be slidable along a vertical direction within a sliding displacement range between an upper extreme position and a lower extreme position, and can stop at any position within the sliding displacement range to form a stopping position for positioning the adjusting rod 40. The vertical direction refers to the up-down orientation as depicted in FIG. 11A.

When the cord fabric 30 is lifted, the falling element 60 abuts against the adjusting rod 40 and is lifted together with the cord fabric 30. When the cord fabric 30 is lowered, the falling element 60 and the adjusting rod 40 are first lowered together with the cord fabric 30 until the pair of positioning elements 50 positions the adjusting rod 40 at the stopping position, and subsequently, the falling element 60 continues to be lowered together with the cord fabric 30.

In this embodiment, the pair of positioning elements 50 is no longer fixed to a preset height of the window 900, but is slidable along the vertical direction and can stop at any height between the upper and lower extreme positions. This enables the user to flexibly and precisely set the stopping position of the adjusting rod 40 according to actual needs, achieving flexible adjustment in the height direction, further satisfying diverse user requirements, and enhancing the user experience.

In some embodiments, referring to FIGS. 11A to 14, the cord fabric 30 is the same as that shown in the embodiment of FIGS. 1 to 10, i.e., the cord fabric 30 includes exactly one light-transmitting section 31 and exactly one light-tight section 32. One end of the light-transmitting section 31 is connected to one end of the light-tight section 32. The end of the light-transmitting section 31 away from the light-tight section 32 is the head end of the cord fabric 30, and the end of the light-tight section 32 away from the light-transmitting section 31 is the tail end of the cord fabric 30. In this embodiments, the light-tight section 32 is made of light-impervious fabric. The light-transmitting section 31 can be formed by light-transmitting fabric, or can be formed by providing one or more hollow portions on the cord fabric 30.

The user can control the suspension height of the adjusting rod 40 by the positioning elements 50, and combine it with the lifting/lowering operation of the cord fabric 30, enabling the shade to achieve a full light-transmitting state, a full light-tight state, an only lower light-transmitting state, an only upper light-transmitting state, as well as an upper and lower simultaneous light-transmitting, middle light-tight state.

Specifically, to achieve the full light-transmitting state, it is just require the cord fabric 30 be completely wound onto the roller 22, in which both the adjusting rod 40 and the falling element 60 are located at the top edge 901 of the window 900. In this state, light passes through the window 900 without obstruction.

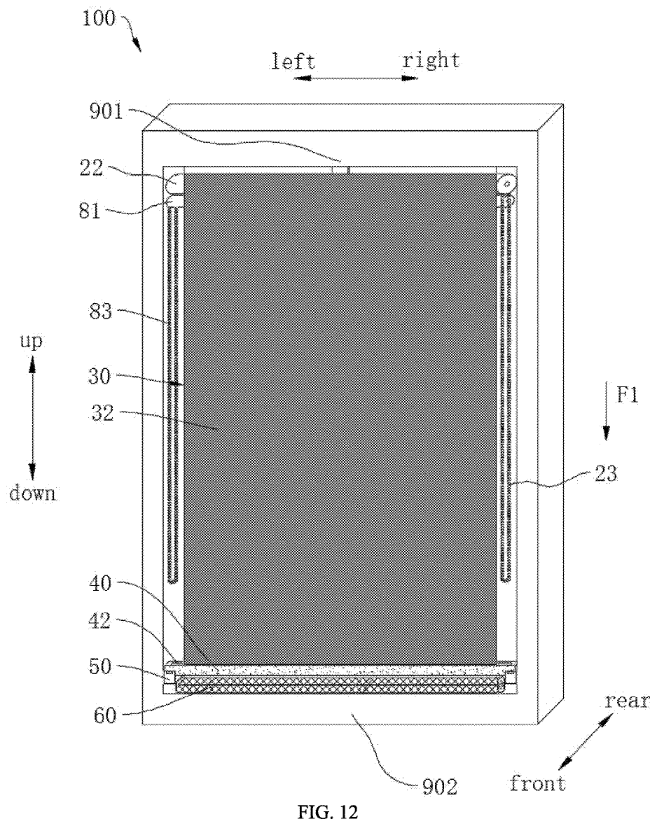

To achieve the full light-tight state, referring to FIG. 12, the positioning elements 50 slide to the lower extreme position, and the adjusting rod 40 and the falling element 60 descend together to the bottom edge 902 of the window 900. Light is completely blocked by the light-tight section 32 of the cord fabric 30, which is configured in a single-layer structure in this area.

To achieve the only lower light-transmitting state, referring to FIG. 11A, the positioning elements 50 are slid to a stopping position at a certain preset height between the upper and lower extreme positions. The adjusting rod 40 and the falling element 60 descend together to this stopping position.

Light in the area from the window's top edge 901 to the stopping position is blocked by the light-tight section 32 of the cord fabric 30, which is configured in a single-layer structure in this area. The area from the stopping position to the bottom edge 902 of the window 900 is unobstructed by the cord fabric, allowing light to pass through.

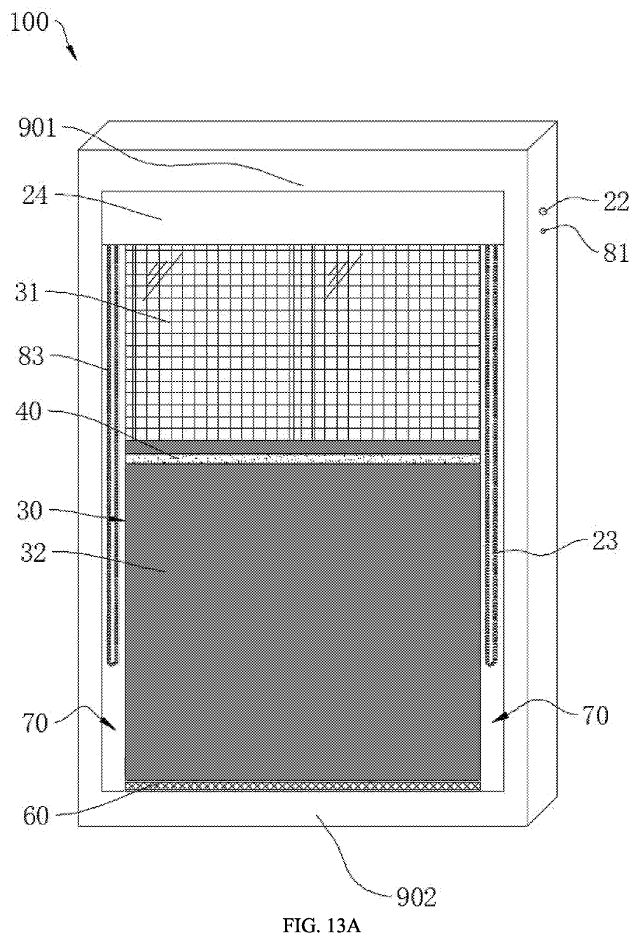

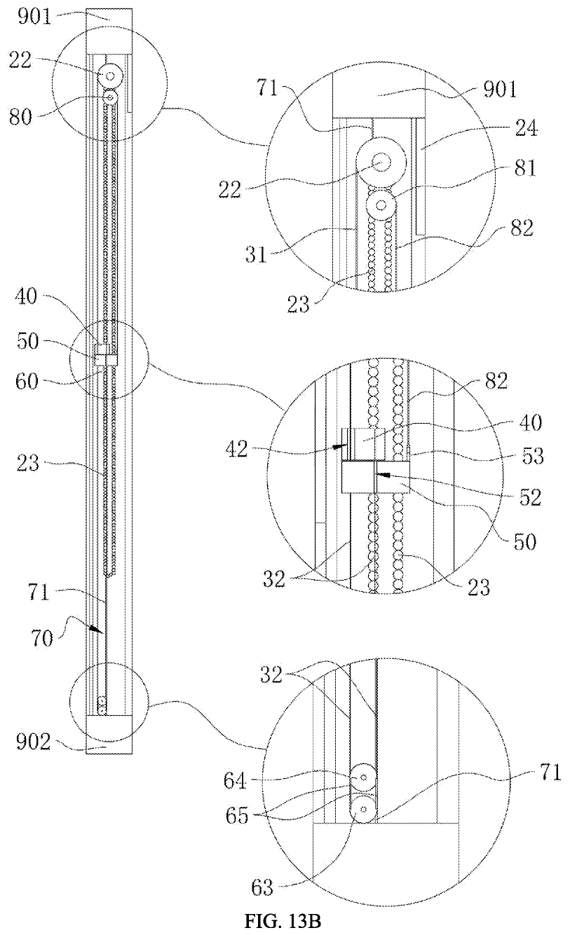

To achieve the only upper light-transmitting state, referring to FIGS. 13A and 13B, the positioning elements 50 are slid to a stopping position at a certain preset height between the upper and lower extreme positions. The adjusting rod 40 descends to this stopping position, and the falling element 60 descends to the bottom edge 902 of the window 900.

Light in the area from the top edge 901 of the window 900 to the stopping position can pass through the window 900 via the light-transmitting section 31 of the cord fabric 30, which is configured in a single-layer structure in this area. Light in the area from the stopping position to the bottom edge 902 of the window 900 is blocked by the light-tight section 32 of the cord fabric 30, which is configured in a double-layer structure 320 in this area.

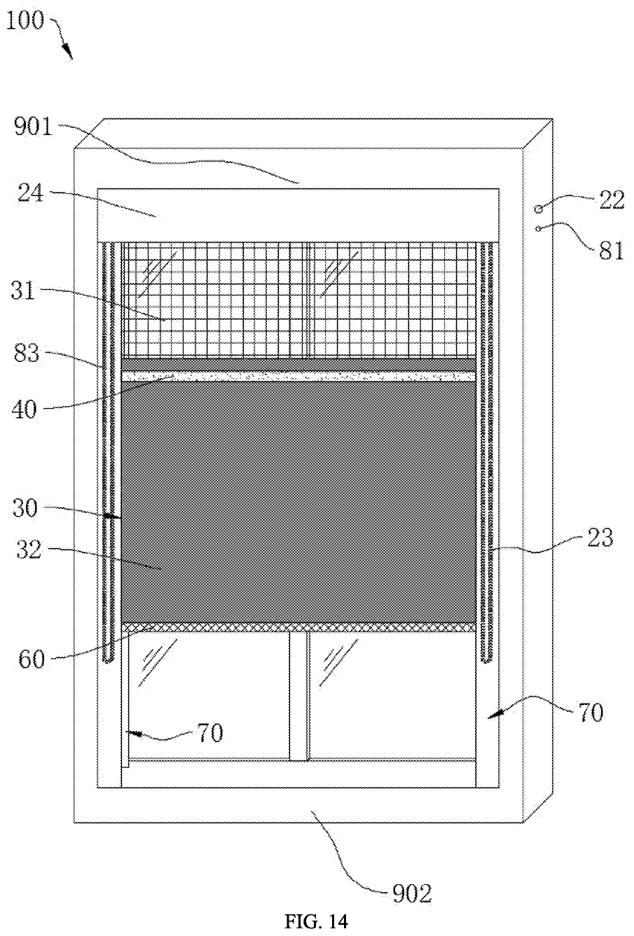

To achieve the upper and lower simultaneous light-transmitting, middle light-tight state, referring to FIG. 14, the positioning elements 50 slide to a stopping position at a certain preset height between the upper and lower extreme positions. The adjusting rod 40 descends to this stopping position, and the falling element 60 descends to a certain position between the stopping position and the bottom edge 902 of the window 900.

Light in the area from the top edge 901 of the window 900 to the stopping position can pass through the window 900 via the light-transmitting section 31 of the cord fabric 30, which is configured in a single-layer structure in this area. Light in the area from the stopping position to the falling element 60 is blocked by the light-tight section 32 of the cord fabric 30, which is configured in a double-layer structure 320 in this area. The area from the falling element 60 to the bottom edge 902 of the window 900 is unobstructed by the cord fabric, allowing light to pass through.

In some embodiments, referring to FIGS. 15 to 22, the cord fabric 30 is configured as a Zebra shade fabric, which includes a plurality of light-transmitting sections 31 and a plurality of light-tight sections 32 alternately arranged along its stretching direction F1 from the head end to the tail end. Each of the light-transmitting sections 31 and the light-tight sections 32 is elongated with its length extending in the lateral direction perpendicular to the vertical direction, wherein the lateral direction refers to the left-right orientation as depicted in FIG. 11A. The width of each light-transmitting section 31 along the vertical direction is substantially the same as the width of each light-tight section 32 along the vertical direction.

With this structure, when light passes through the cord fabric 30, which is configured in a single-layer structure, the light-tight sections 32 block the light while the light-transmitting sections 31 allow the light to pass through, creating a visually alternating pattern of light and dark stripes, similar in appearance to zebra stripes. When the cord fabric 30 is configured as a double-layer structure, the user can, through lifting/lowering operations and precise control of the falling element 60, continuously and steplessly adjust the relative overlap relationship in the height direction between the plurality of light-transmitting sections 31 of one layer of the cord fabric 30 and the plurality of light-transmitting sections 31 or light-tight sections 32 of the other layer of the cord fabric 30. This enables smooth switching among various working states such as full light-transmitting, interval light-transmitting, and full light-tight, thereby achieving an optimized balance between light control, visual comfort, spatial aesthetics, and privacy protection.

Specifically, the user can control the suspension height of the adjusting rod 40 through the positioning elements 50, and combine it with the lifting/lowering operation of the cord fabric 30, enabling the cord fabric 30 with this zebra-stripe-like structure to achieve: a full light-transmitting state; an upper interval light-transmitting state; a full interval light-transmitting state; a full light-tight state; an upper interval light-transmitting, middle light-tight, lower light-transmitting state; and an upper interval light-transmitting, lower light-tight state.

Specifically, to achieve the full light-transmitting state, the cord fabric 30 is completely wound onto the roller 22, and both the adjusting rod 40 and the falling element 60 are located at the top edge 901 of the window 900. Light passes through the window 900 without obstruction.

The upper interval light-transmitting state can be achieved in the following two ways:

In the first way, referring to FIG. 15, the positioning elements 50 are slid to a stopping position at a certain preset height between the upper and lower extreme positions. The adjusting rod 40 and the falling element 60 descend together to this stopping position.

The cord fabric 30 in the area from the top edge 901 of the window 900 to the stopping position is a single-layer structure. Light passes through the window 900 at intervals via the plurality of light-transmitting sections 31, achieving interval light transmission. The area from the stopping position to the bottom edge 902 of the window 900 is unobstructed by the cord fabric 30, allowing light to pass through completely.

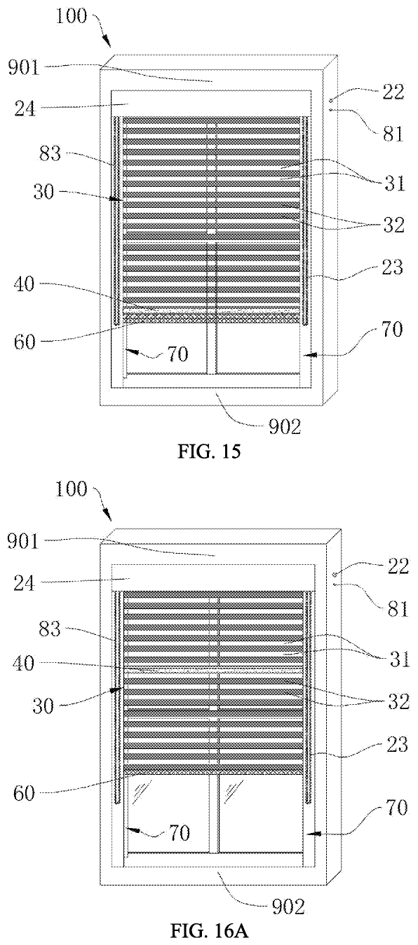

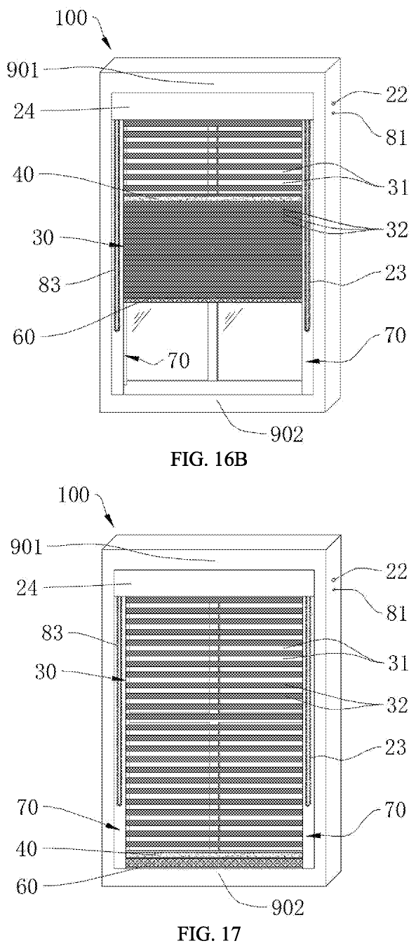

In the second way, referring to FIG. 16A, the positioning elements 50 are slid to a stopping position at a certain preset height between the upper and lower extreme positions. The adjusting rod 40 descends to this stopping position, and the falling element 60 descends to a certain position between the stopping position and the bottom edge 902 of the window 900.

The cord fabric 30 in the area from the top edge 901 of the window 900 to the stopping position is a single-layer structure. Light passes through the window 900 at intervals via the plurality of light-transmitting sections 31, achieving interval light transmission. The cord fabric 30 in the area from the stopping position to the falling element 60 is a double-layer structure 320. By finely adjusting the cord fabric 30 along the stretching direction F1, the plurality of light-transmitting sections 31 of the double-layer cord fabric 30 in this area are made to overlap and align in the height direction. Light similarly passes through the window 900 at intervals via the plurality of light-transmitting sections 31. The area from the falling element 60 to the bottom edge 902 of the window 900 is unobstructed, allowing light to pass through completely.

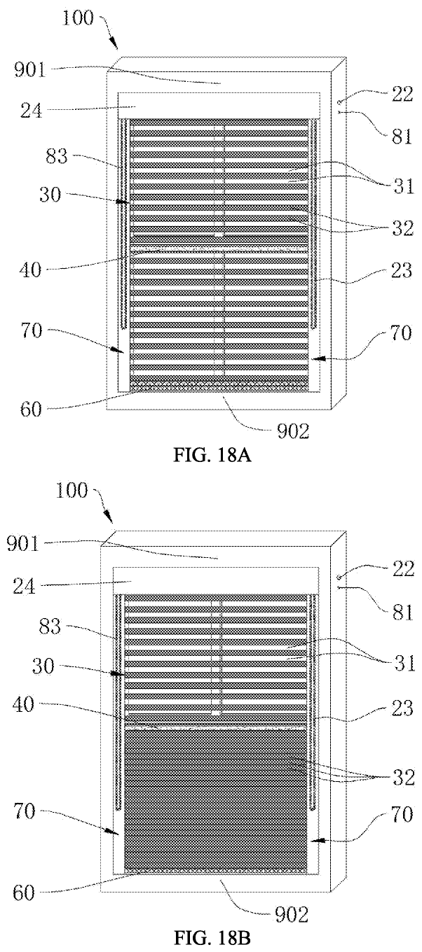

For the full interval light-transmitting state, referring to FIGS. 17 and 18A. Its implementation is similar to the two ways of the upper interval light-transmitting state. The difference is that the falling element 60 descends to the bottom edge 902 of the window 900, rather than to a certain position between the stopping position and the bottom edge 902 of the window 900. The other similar parts are not repeated here.

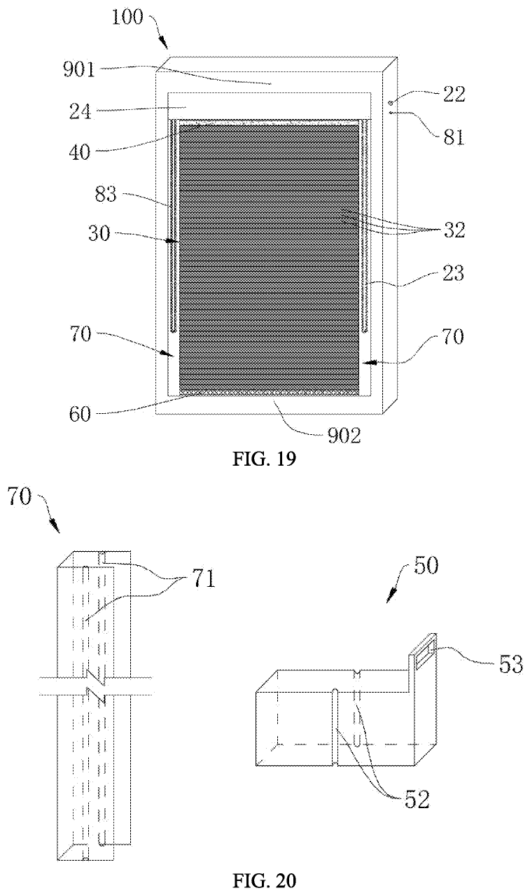

To achieve the full light-tight state, referring to FIG. 19, the positioning elements 50 are slid to the upper extreme position (e.g., the top edge 901 of the window 900). The adjusting rod 40 is stopped by the positioning elements 50 at the upper extreme position, and the falling element 60 descends to the bottom edge 902 of the window 900. At this time, the cord fabric 30 below the adjusting rod 40 forms a double-layer structure 320. By finely adjusting the cord fabric 30 along the stretching direction F1, the plurality of light-tight sections 32 and the plurality of light-transmitting sections 31 of the double-layer cord fabric are made to overlap and align in the height direction, and light is completely blocked.

To achieve the upper interval light-transmitting, middle light-tight, lower light-transmitting state, referring to FIG. 16B, its implementation is similar to the second way of the upper interval light-transmitting state. The difference is that by finely adjusting the cord fabric 30 along the stretching direction F1, the plurality of light-tight sections 32 and the plurality of light-transmitting sections 31 of the double-layer cord fabric 30 between the stopping position and the falling element 60 are made to overlap and align in the height direction, so that light is completely blocked in that area. The other similar parts are not repeated here.

To achieve the upper interval light-transmitting, lower light-tight state, referring to FIG. 18B, its implementation is similar to the upper interval light-transmitting, middle light-tight, lower light-transmitting state. The difference is that the falling element 60 descends to the bottom edge 902 of the window 900, rather than to a certain position between the stopping position and the bottom edge 902 of the window 900. The other similar parts are not repeated here.

In some embodiments, referring to FIGS. 11A to 20, the multi-mode up-down shade 100 further includes a pair of sliding channels 70 respectively fixedly installed on the two lateral sides of the window 900. Each of the pair of positioning elements 50 is a block slidably disposed within a corresponding one of the pair of sliding channels 70. Specifically, the sliding channel 70 extends in the vertical direction and has an opening formed on one side. The block serving as the positioning element 50 is slidably disposed within the sliding channel 70 through its opening, thereby achieving sliding along the vertical direction.

Similar to the embodiment shown in FIGS. 1 to 10, the adjusting rod 40 in this embodiment extends in the lateral direction, and the penetrating slot 42 penetrates through the adjusting rod 40 along the vertical direction, wherein the lateral direction, which is perpendicular to the vertical direction, refers to the left-right orientation as depicted in FIG. 11A.

When the cord fabric 30 is lowered, the pair of positioning elements 50 stopped at the stopping position are capable of respectively abutting against the left and right ends of the adjusting rod 40 from below to block the adjusting rod 40 from descending.

In this embodiment, the positioning element 50 is a rectangular block, and the sliding channel 70 is a rectangular channel adapted to the shape of the rectangular block. It should be understood that the shape profiles of the sliding channel 70 and the slider are not limited to rectangular. In other embodiments, shapes such as circular, trapezoidal, T-shaped, or other adapted cross-sectional shapes may also be used, as long as the slider can slide smoothly within the sliding channel 70. The sliding channel 70 can provide stable guidance and limitation for the positioning element 50 along the vertical direction, ensuring it does not deviate during the lifting/lowering process, thereby improving the reliability and smoothness of movement.

In some embodiments, referring to FIG. 11A, in the pair of sliding channels 70, an opening of one sliding channel 70 faces toward an opening of the other sliding channel 70. That is, in the pair of sliding channels 70, the opening of the sliding channel 70 located on the left side faces right, and the opening of the sliding channel 70 located on the right side faces left. This design prevents the openings of the sliding channels 70 from being directly exposed to the user's view from the front, thereby improving the overall aesthetics of the shade.

In some embodiments, referring to FIGS. 11A, 11B, 13A, 13B, and 20, to further improve the stability and smoothness of guidance, each positioning element 50 and a corresponding one of the sliding channels 70 are slidably engaged with each other by at least one guiding rib 71 and at least one guiding groove 52. In this embodiment, the positioning element 50 is provided with a guiding groove 52 on each of its two opposing side surfaces. The sliding channel 70 is provided with a guiding rib 71 on each of its two opposite inner surfaces. The guiding rib 71 and the guiding groove 52 are slidably engaged along the vertical direction.

In other embodiments, the guiding rib 71 may also be provided on the positioning element 50, and the guiding groove 52 may be provided on the sliding channel 70, which can also achieve guiding function.

In some embodiments, a tight fit may be adopted between the sliding channel 70 and the positioning element 50, for example, achieved by interference fit. The friction generated between them can provide the necessary supporting force for the positioning element 50 when it abuts against the adjusting rod 40 from below. The user can manually slide the positioning element 50 within the sliding channel 70, adjust it, and maintain it at the desired stopping position, thereby achieving flexible setting of the suspension height of the adjusting rod 40.

To improve operational convenience and user experience, in some embodiments, referring to FIGS. 11B and 13B, the multi-mode up-down shade 100 further includes a traction assembly 80 configured to drive the pair of positioning elements 50 to slide along the vertical direction within the sliding channels 70. The traction assembly 80 can adopt various driving forms, including but not limited to motor, manual pull cords, hand-crank devices, rope and pulley systems, or other transmission mechanisms, as long as it can achieve stable and controllable sliding of the positioning elements 50 within the sliding channels 70. This design allows the user to easily and precisely adjust the height position of the positioning elements 50, thereby further enhancing the convenience of switching between the various working states of the shade.

In this embodiment, referring to FIGS. 11A, 11B, 13A, 13B, 21, and 22, the traction assembly 80 includes a traction reel 81 and a pair of flexible traction members 82 that are entirely or partially wound around the outer periphery of the traction reel 81. The head ends of the pair of flexible traction members 82 are fixedly connected to the traction reel 81, and the tail end of each flexible traction member 82 away from the traction reel 81 is fixedly connected to one of the pair of positioning elements 50.

The flexible traction members 82 include, but are not limited to, ropes, belts, strings, etc., used for transmitting pulling force. In this embodiment, the flexible traction members 82 are belts. A clearance fit is adopted between the sliding channel 70 and the positioning element 50 to facilitate smooth sliding of the positioning element 50 along the sliding channel 70 under the drive of the flexible traction members 82. In other words, the vertical sliding of the positioning element 50 within the sliding channel 70 is achieved by the rotation of the traction reel 81 driving the winding and unwinding of the flexible traction members 82.

In one embodiment, referring to FIGS. 11A, 11B, 13A, 13B, and 21, to facilitate user operation, the traction assembly 80 further includes a traction string 83 for driving the traction reel 81 to rotate. The traction string 83 is a looped transmission chain. One end is hooked to the traction reel 81, and the other end extends downward to a lower area of the window 900 for the user to manually pull, thereby controlling the rotation of the traction reel 81.

To prevent the positioning elements 50 from sliding down within the sliding channels 70 due to their own gravity when no external force is applied, the rotation of the traction reel 81 is a damped rotation. It can maintain its current position after the user stops applying force, thereby stably maintaining the stopping height of the positioning elements 50.

In one embodiment, referring to FIGS. 20 and 22, to facilitate a reliable connection between the flexible traction members 82 and the positioning elements 50, each positioning element 50 is provided with a lifting lug 53. The end of each flexible traction member 82 is fixed to the lifting lug 53 of one of the pair of positioning elements 50 by winding or knotting, thereby achieving effective transmission of traction force from the flexible traction member 82 to the positioning element 50.

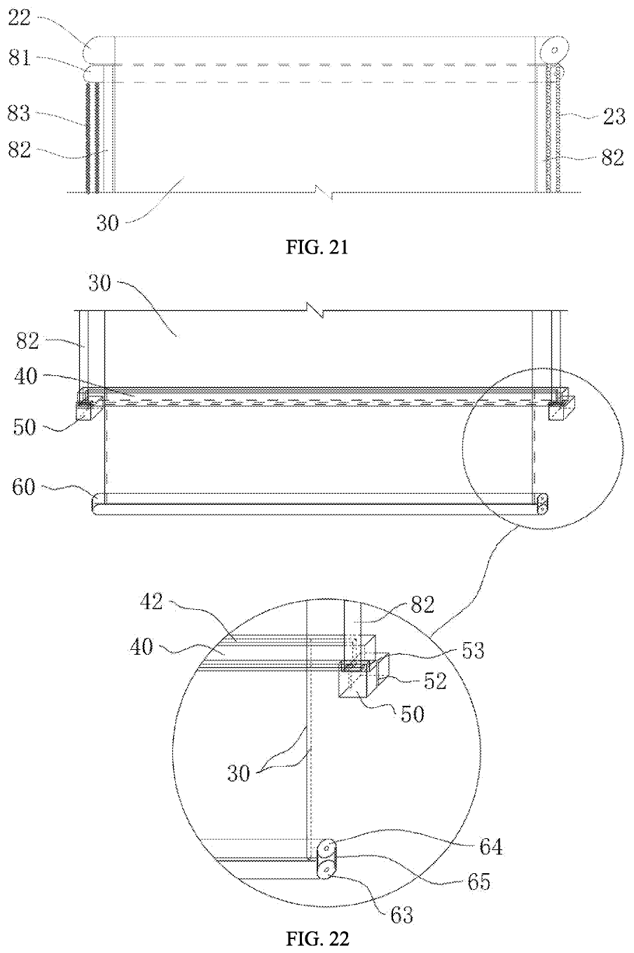

In one embodiment, referring to FIGS. 11A and 21, the traction string 83 is arranged on one of the lateral sides of the window 900 for convenient user operation.

Optionally, in one embodiment, referring to FIGS. 11A and 21, the adjusting string 23 for controlling the lifting/lowering of the cord fabric 30 and the traction string 83 are arranged opposite to each other on the lateral sides of the window 900. This arrangement not only distributes the operation areas clearly, facilitating the user to quickly identify different functional strings, but also facilitates two-handed coordinated operation and prevents the strings from tangling with each other, thereby enhancing convenience of use and the overall experience.

In one embodiment, referring to FIGS. 11A, 11B, 13A, and 13B, the roller 22 and the traction reel 81 are installed on the window 900 and are adjacent to its top edge 901. The traction reel 81 is arranged parallel to and spaced below the roller 22. This can reduce the overall thickness in the longitudinal direction, making the overall structure of the shade more compact, wherein the longitudinal direction, which is perpendicular to the vertical direction and the lateral direction, refers to the front-rear orientation as depicted in FIG. 11.

Preferably, in one embodiment, referring to FIGS. 11A, 11B, 13A, and 13B, the multi-mode up-down shade 100 further includes a shielding member 24 installed on the top edge 901 of the window 900. The shielding member 24 is arranged on the front side of the roller 22 and the traction reel 81. For example, the shielding member 24 may be a plate-like structure installed on the window's top edge 901 and extending downward. It is used to shield the roller 22 and the traction reel 81 from the front side of the window 900, preventing them from being directly exposed to the user's view, thereby enhancing the overall aesthetics of the product's appearance.

In one embodiment, referring to FIGS. 11A, 11B, 13A, and 13B, the falling element 60 includes a contact reel 64 and a falling reel 63 arranged parallel to and spaced below the contact reel 64. The middle part of the cord fabric 30 is slidably threaded between the contact reel 64 and the falling reel 63.

Specifically, referring to FIGS. 11A, 11B, 13A, 13B, and 22, the falling element 60 includes at least one connecting member 65. Two ends of the falling reel 63 are connected to two ends of the contact reel 64 via the at least one connecting member 65. Optionally, both the falling reel 63 and the contact reel 64 extend in the lateral direction. The connecting member 65 is substantially a strip structure. The left and right ends of the falling reel 63 are respectively connected to the left and right ends of the contact reel 64 via two connecting members 65. The connecting member 65 is used to maintain the spacing between the falling reel 63 and the contact reel 64. Under the action of gravity, the contact reel 64 always maintains slidable contact with the middle part of the cord fabric 30, while the falling reel 63 is located below the cord fabric 30 to provide tension for keeping the cord fabric taut. Of course, the falling element 60 may also adopt the structures described above and shown in FIGS. 8, 9A, and 9B.

The above embodiments are merely to describe preferred embodiments of the present disclosure, not limited to the scope of the present disclosure. Any changes and variations made by those skilled in the art without departing from the spirit and scope of the present disclosure, should be fall into the protection scope of the claims of the present disclosure.

1. A multi-mode up-down shade, comprising:
a roller;
a cord fabric, entirely or partially wound around an outer periphery of the roller, wherein a head end of the cord fabric is fixedly connected to the roller, and the cord fabric comprises at least one light-transmitting section and at least one light-tight section;
an adjusting rod, fixedly connected to a tail end of the cord fabric away from the roller;
wherein the adjusting rod is provided with a penetrating slot, a middle part of the cord fabric is slidably threaded through the penetrating slot, and the middle part of the cord fabric is a region located between the head end and the tail end of the cord fabric;
a falling element, slidably mounted on the middle part of the cord fabric and located below the adjusting rod, so that the middle part of the cord fabric is folded below the adjusting rod to form a double-layer structure; and
a pair of positioning elements, configured to be slidable along a vertical direction within a sliding displacement range between an upper extreme position and a lower extreme position, and configured to stop at any position within the sliding displacement range to form a stopping position for positioning the adjusting rod;
wherein, when the cord fabric is lifted, the falling element abuts against the adjusting rod and is lifted together with the cord fabric; and
wherein when the cord fabric is lowered, the falling element and the adjusting rod are first lowered together with the cord fabric until the adjusting rod is blocked by the pair of positioning elements at the stopping position, and the falling element continues to be lowered together with the cord fabric.

2. The multi-mode up-down shade according to claim 1, wherein the at least one light-transmitting section comprises exactly one light-transmitting section, and the at least one light-tight section comprises exactly one light-tight section; one end of the light-transmitting section is connected to one end of the light-tight section; an other end of the light-transmitting section away from the light-tight section is the head end of the cord fabric, and an other end of the light-tight section away from the light-transmitting section is the tail end of the cord fabric.

3. The multi-mode up-down shade according to claim 1, wherein the cord fabric is configured as a Zebra shade fabric; and wherein the at least one light-transmitting section comprises a plurality of light-transmitting sections, the at least one light-tight section comprises a plurality of light-tight sections, and the plurality of light-transmitting sections and the plurality of light-tight sections are alternately arranged along a stretching direction from the head end to the tail end of the cord fabric.

4. The multi-mode up-down shade according to claim 1, further comprising a pair of sliding channels, wherein one of the pair of sliding channels is fixedly installed on one side of a window along a lateral direction, and an other of the pair of sliding channels is fixedly installed on an other side of the window along the lateral direction; each of the pair of positioning elements is a block slidably disposed within a corresponding one of the pair of sliding channels.

5. The multi-mode up-down shade according to claim 4, wherein each positioning element and one of the pair of sliding channels are slidably engaged with each other by at least one guiding rib and at least one guiding groove.

6. The multi-mode up-down shade according to claim 4, wherein, in the pair of sliding channels, an opening of one sliding channel faces toward an opening of an other sliding channel.

7. The multi-mode up-down shade according to claim 1, further comprising a traction assembly configured to drive the pair of positioning elements to slide along the vertical direction.

8. The multi-mode up-down shade according to claim 7, wherein the traction assembly comprises a traction reel and a pair of flexible traction members entirely or partially wound around an outer periphery of the traction reel; head ends of the pair of flexible traction members are fixedly connected to the traction reel, and a tail end of each flexible traction member away from the traction reel is respectively fixedly connected to one of the pair of positioning elements.

9. The multi-mode up-down shade according to claim 8, wherein each positioning element comprises a lifting lug, and each flexible traction member is fixedly tied to the lifting lug of one of the pair of positioning elements.

10. The multi-mode up-down shade according to claim 8, wherein the traction assembly further comprises a traction string for driving the traction reel to rotate, and the traction string is arranged on one side of a window along a lateral direction.

11. The multi-mode up-down shade according to claim 10, further comprising an adjusting string for driving the roller to rotate; wherein one of the adjusting string and the traction string is arranged on one side of the window along the lateral direction, an other thereof is arranged on an other side of the window along the lateral direction.

12. The multi-mode up-down shade according to claim 8, wherein the roller and the traction reel are installed adjacent to a top edge of the window, and the traction reel is arranged parallel to and spaced below the roller.

13. The multi-mode up-down shade according to claim 12, further comprising a shielding member installed on the top edge of the window, and the shielding member is arranged on a front side of the roller and the traction reel.

14. The multi-mode up-down shade according to claim 1, wherein the falling element comprises a contact reel and a falling reel arranged parallel to and spaced below the contact reel; the middle part of the cord fabric is slidably threaded between the contact reel and the falling reel.

15. The multi-mode up-down shade according to claim 14, wherein the falling element comprises at least one connecting member; two ends of the falling reel are respectively connected to two ends of the contact reel via the at least one connecting member.

16. The multi-mode up-down shade according to claim 1, wherein when the cord fabric is lowered, the pair of positioning elements stopped at the stopping position are configured to respectively abut against two ends of the adjusting rod from below to block the adjusting rod from descending.

17. The multi-mode up-down shade according to claim 1, wherein the adjusting rod extends along a lateral direction, and the penetrating slot penetrates through the adjusting rod along the vertical direction.
